(19) United States
(12) Patent Application Publication
(10) Pub. No.: US 2022/0127882 A1
(43) Pub. Date: Apr. 28, 2022

(54) CLAMPING DEVICE

(71) Applicant: SINOX CO., LTD, New Taipei City (TW)

(72) Inventor: Chia-Ming WU, New Taipei City (TW)

(73) Assignee: SINOX CO., LTD, New Taipei City (TW)

(21) Appl. No.: 17/492,875

(22) Filed: Oct. 4, 2021

(30) Foreign Application Priority Data
Oct. 22, 2020 (TW) 109213926

(51) Int. Cl. E05B 73/00; E05B 47/00

(52) U.S. Cl. CPC E05B 73/0082; E05B 73/0064; E05B 47/0012

(57) ABSTRACT

A clamping device is provided. The clamping device includes a body, at least a hook, and a driving device. The hook is supported by the body, wherein the hook is capable of moving selectively to a first locked position and an unlocked position. A portion of the hook is disposed in the driving device. The hook moves to the first locked position and is capable of engaging with the lock hole of the electronic device when the driving device rotates to a first pre-determined position.

### BACKGROUND

### Field of the Invention

The present invention generally relates to a clamping device. More particularly, the present invention relates to a clamping device for use with an electronic device.

### Related Art

In modern life, consumer electronic products play an important role. With today's fast lifestyle and people's demand for instantaneous information, portable electronic products have become one of the necessities of modern life. However, due to their relatively high unit prices and the ease of turning them into cash, these products are more likely to be stolen or robbed.

In order to prevent others from stealing these products, a lock device may be designed. For example: a notebook computer lock that may be connected to an anti-theft lock hole of an electronic product through a lock fastener of the notebook computer lock, where the movement of the lock fastener is controlled through a key lock mechanism to complete the locking/unlocking. However, the anti-theft lock holes have different specifications. A user needs to purchase/carry a lock with each corresponding lock fastener according to the specification of the anti-theft lock hole, making it uneconomical and inconvenient to use.

### SUMMARY OF THE INVENTION

The object of the present invention is to provide a clamping device for engaging with a lock hole of an electronic device which is more convenient to use to resolve the issues of the prior arts.

The clamping device includes a body, at least a hook, and a driving device. The hook is supported by the body, wherein the hook is capable of moving selectively to a first locked position and an unlocked position. A portion of the hook is disposed in the driving device. The hook moves to the first locked position and is capable of engaging with the lock hole of the electronic device when the driving device rotates to a first pre-determined position.

In one embodiment, the hook is capable of further moving to a second locked position when the driving device rotates to a second pre-determined position.

In one embodiment, a portion of the hook inside the driving device is propped against the inner wall of the driving device.

In one embodiment, the distance between the inner wall of the driving device and the rotation axis of the driving device changes along the circumferential direction.

In one embodiment, the driving device is capable of rotating along a plane parallel to a Y-Z plane. The hook is capable of rotating along a plane parallel to an X-Z plane. The X-axis, Y-axis, and Z-axis are orthogonal.

In one embodiment, the clamping device further includes a lock body disposed on a side of the driving device. The lock body is capable of locking to restrict the hook from moving when the driving device rotates to the first pre-determined position.

In one embodiment, when the driving device rotates to the first pre-determined position, the lock body is capable of locking to restrict the driving device from rotating and hence restrict the hook from moving.

In one embodiment, the lock body includes a movement restricting piece. The movement restricting piece is capable of moving along the direction parallel to an X-axis to be propped against the driving device when the driving device rotates to the first pre-determined position.

In one embodiment, the clamping device further includes a force applying device disposed on a different side of the driving device with respect to the lock body. The force applying device is capable of rotating to make the driving device rotate.

In one embodiment, the force applying device is capable of rotating along a plane parallel to the X-Z plane.

### BRIEF DESCRIPTION OF THE DRAWINGS

FIG. 1 is a perspective view of an embodiment of the clamping device of the present invention for engaging with a lock hole of an electronic device.

FIGS. 2A and 2B are exploded views of an embodiment of the clamping device of the present invention.

FIGS. 3A and 3B are perspective views of an embodiment of the clamping device of the present invention showing a hook of the clamping device in an unlocked position.

FIGS. 4A and 4B are perspective views of an embodiment of the clamping device of the present invention showing a hook of the clamping device in the first locked position.

FIGS. 5A and 5B are perspective views of an embodiment of the clamping device of the present invention showing a hook of the clamping device in the second locked position.

FIG. 6 is a perspective view of an embodiment of the clamping device of the present invention showing the driving bumps engaged with the force applying bumps.

### DETAILED DESCRIPTION

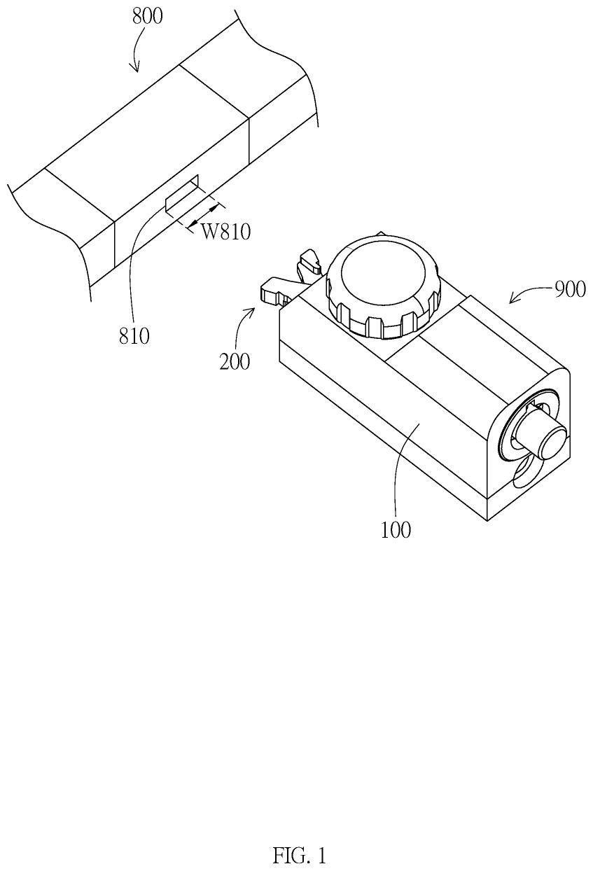

As shown in the embodiment in FIG. 1, the clamping device 900 of the present invention is used in an electronic device 900 for engaging with a lock hole 810 of the electronic device 900. The electronic device is preferably portable, such as, but not limited to, a notebook computer, a tablet, a mobile phone, an e-book, a digital photo frame, a GPS navigator, a mobile network device, a personal digital assistant, a portable media player, and an electronic dictionary, etc.

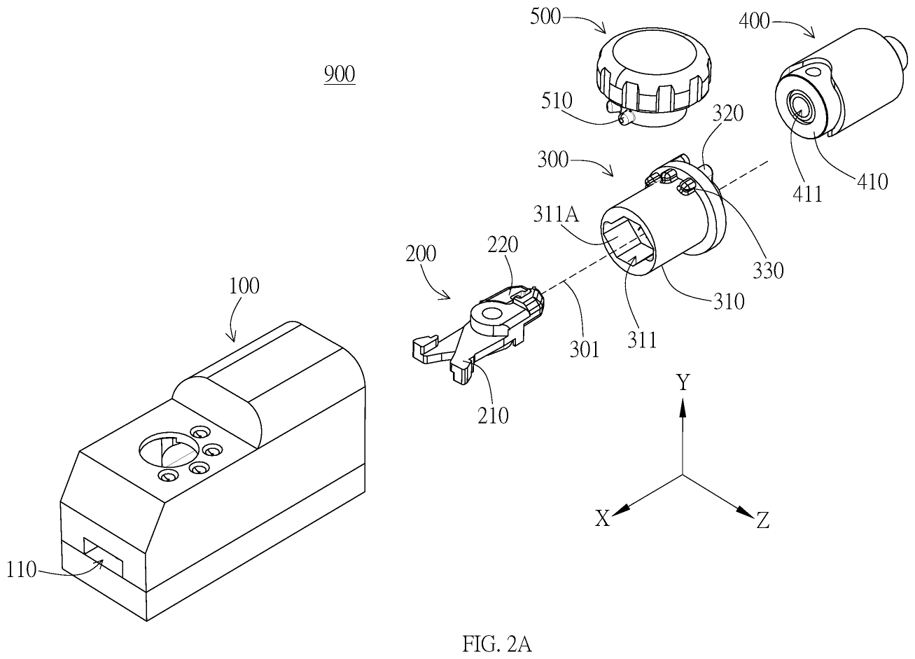

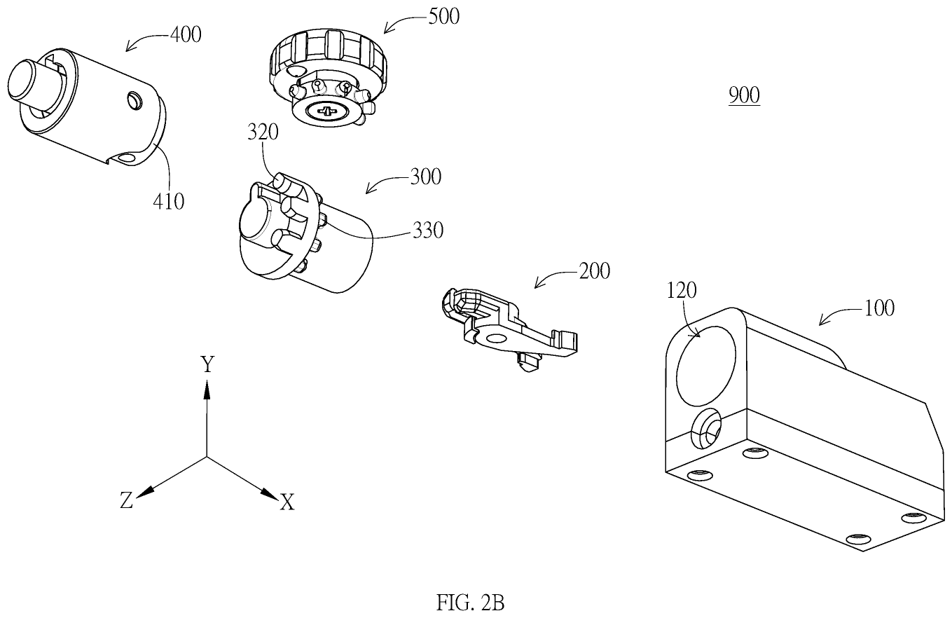

As shown in the embodiments in FIGS. 2A and 2B, the clamping device 900 includes a body 100, at least a hook 200, and a driving device 300. The hook 200 is supported by the body 100, wherein the hook 200 is capable of moving selectively to a first locked position and an unlocked position. A portion of the hook 200 is disposed in the driving device 300. The hook 200 moves to the first locked position and is capable of engaging with the lock hole 810 when the driving device rotates to a first pre-determined position.

More particularly, as shown in the embodiments in FIGS. 2A and 2B, the opposite two ends of the body 100 have respectively a first opening 110 and a second opening 120. The hook 200 is pivotally connected to the body 100 and is capable of rotating along a plane parallel to an X-Z plane, wherein the opposite two ends of the hook 200 have respectively a hooking portion 210 and a driving portion 220. The hooking portion 210 is capable of extending out of the body 100 from the first opening 110. In one embodiment, there is a pair of hooks 200 disposed like a pair of scissors. In different embodiments, however, there could be one or more than 2 hooks and is not limited to being disposed like a pair of scissors. Moreover, the moving of the hook 200 is not limited to rotating and can be level shifting.

As shown in the embodiments in FIGS. 2A and 2B, the driving device 300 is preferably a barrel. One end 310 having a driving device opening 311 is capable of inserting into the body 100 through the second opening 120 and rotating inside the body 100 along a plane parallel to a Y-Z plane. The driving portion 220 of the hook 200 is capable of inserting into the driving device 300 through the driving device opening 311 and propping against the inner wall 311A of the driving device 300. Since the distance between the inner wall 311A of the driving device 300 and the rotation axis 301 of the driving device 300 changes along the circumferential direction, the driving portion 220 propping against the inner wall 311A will move with the rotating of the driving device 300 and hence makes the hook 200 rotate to change the position of the hooking portion 210. In different embodiments, the driving device 300 may not insert into the body 100 and is not limited to a barrel. Moreover, the driving device 300 is not limited to rotating along a plane parallel to the Y-Z plane.

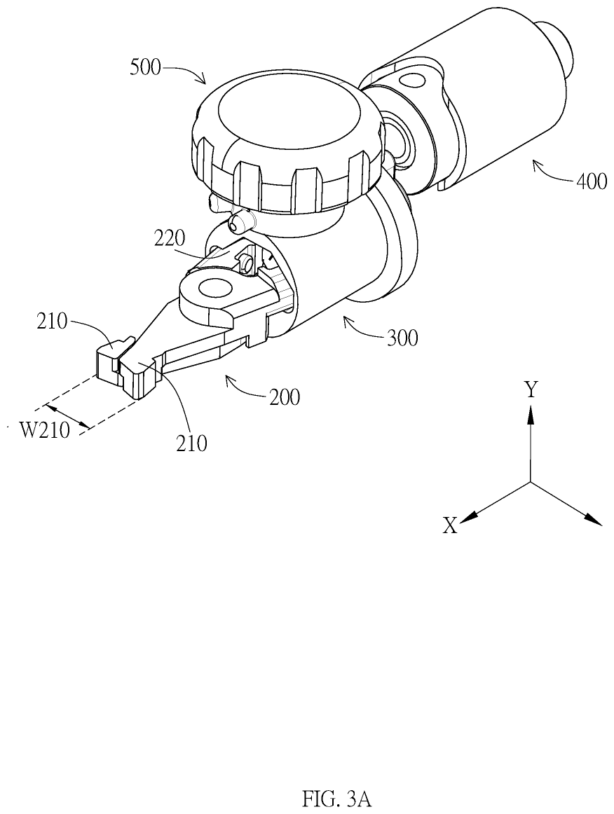

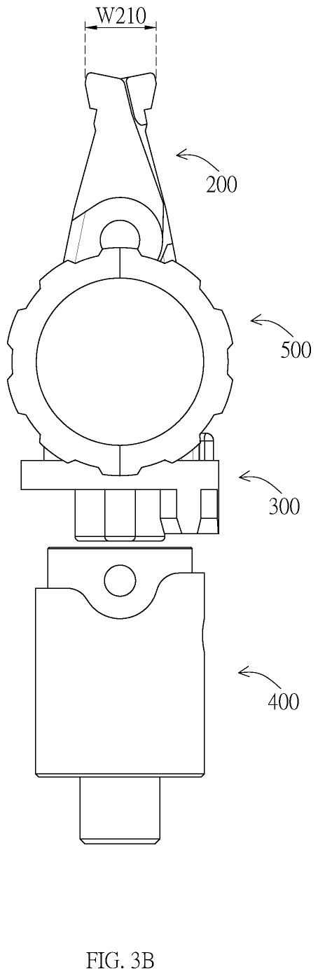

More particularly, FIGS. 3A to 5B are perspective views of an embodiment showing the movement between the hook 200 and the driving device 300. For the purpose of showing the hook 200 and the driving device 300 more clearly, the body 100 is not presented in the figures.

As shown in the embodiments in FIGS. 3A and 3B, the hooks 200 are in the unlocked position. The distance W210 to which the hook portions 210 opens (i.e. moving away from each other) is less than the width W810 of the lock hole 810 (see FIG. 1), i.e. the width of the perpendicular projection of the hook portions 210 on the Y-Z plane is less than the width W810 of the lock hole 810. Therefore, the hooks 200 are capable of freely entering and exiting the lock hole 810.

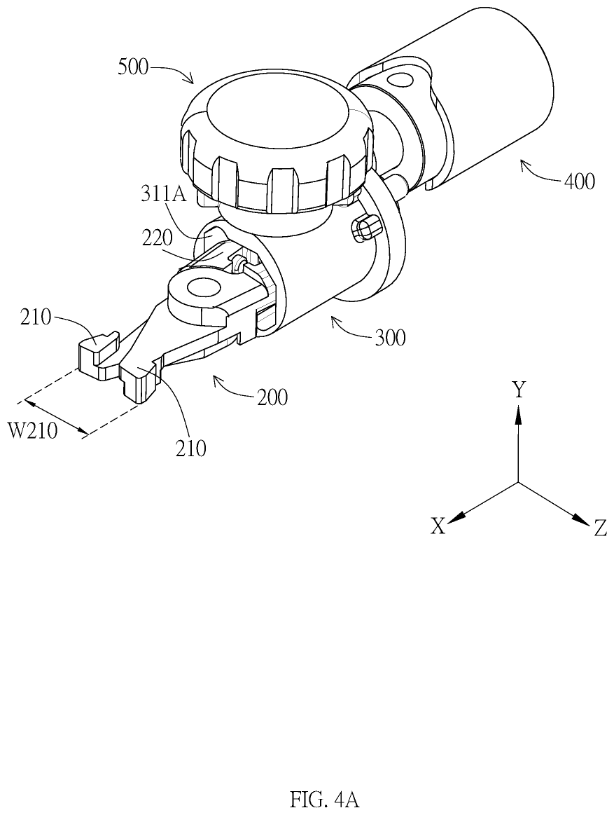

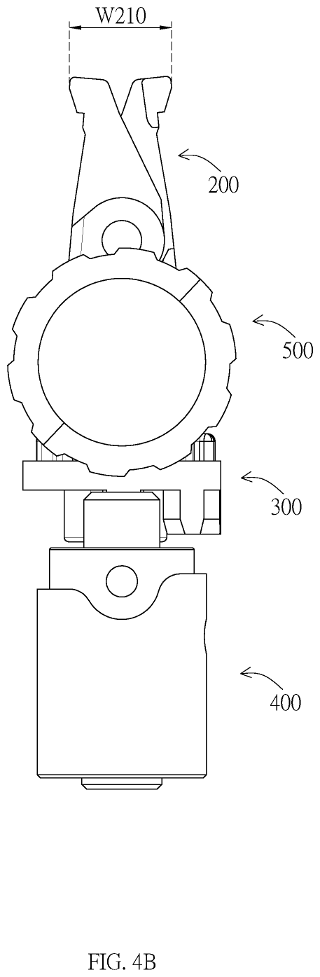

As shown in the embodiments in FIGS. 4A and 4B, when the driving device 300 rotates to the first pre-determined position, the distance between the inner wall 311A of the driving device 300 and the rotation axis 301 (see FIG. 2A) of the driving device 300 increases. Accordingly, the driving portion 220 propped against the inner wall 311A will move away from the rotation axis 301 and make the hook 200 rotate to change the position of the hooking portion 210. Hence, the distance W210 to which the hook portions 210 opens is increased, i.e. making the hooks 200 move to the first locked position. At this time, the hooks 200 are capable of engaging with the lock hole 810 since the distance W210 to which the hook portions 210 opens is larger than the width W810 of the lock hole 810. In one embodiment, an elastic member such as a spring could be disposed between the driving portion 220, wherein the elastic member provides elastic force for making the driving portion 220 prop against the inner wall 311A.

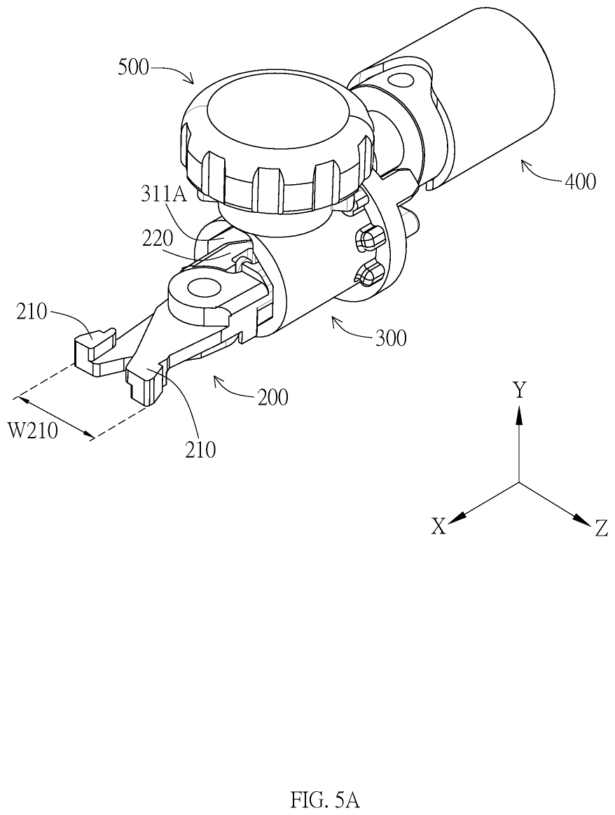

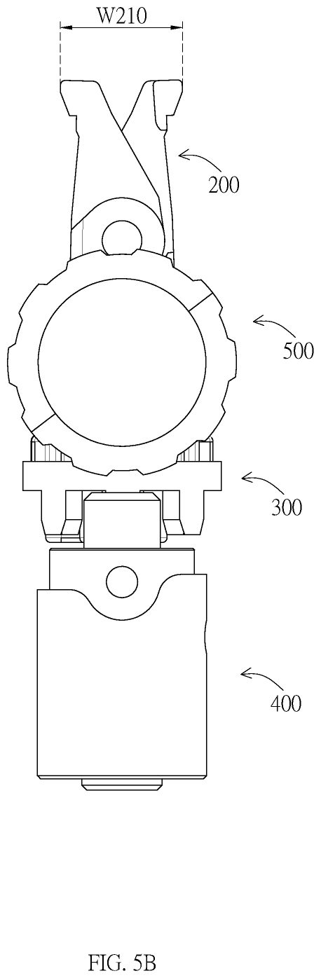

As shown in the embodiments in FIGS. 5A and 5B, when the driving device 300 rotates to the second pre-determined position, the distance between the inner wall 311A of the driving device 300 and the rotation axis 301 (see FIG. 2A) of the driving device 300 further increases. Accordingly, the driving portion 220 propped against the inner wall 311A will move away further from the rotation axis 301 and make the hook 200 rotate to further change the position of the hooking portion 210. Hence, the distance W210 to which the hook portions 210 opens is further increased, i.e. making the hooks 200 move to the second locked position. At this time, the hooks 200 are capable of engaging with a larger lock hole 810. Therefore, the clamping device 900 is capable of engaging with different sizes of lock holes of electronic devices and is more convenient to use.

As shown in the embodiments in FIGS. 2A and 2B, the clamping device 900 further includes a lock body 400 disposed on a side of the driving device 300. The lock body 400 is capable of locking to restrict the hooks 200 from moving when the driving device 300 rotates to the first pre-determined position. More particularly, when the driving device 300 rotates to the first pre-determined position, the lock body 400 is capable of locking to restrict the driving device 300 from rotating and hence to restrict the hooks 200 from moving.

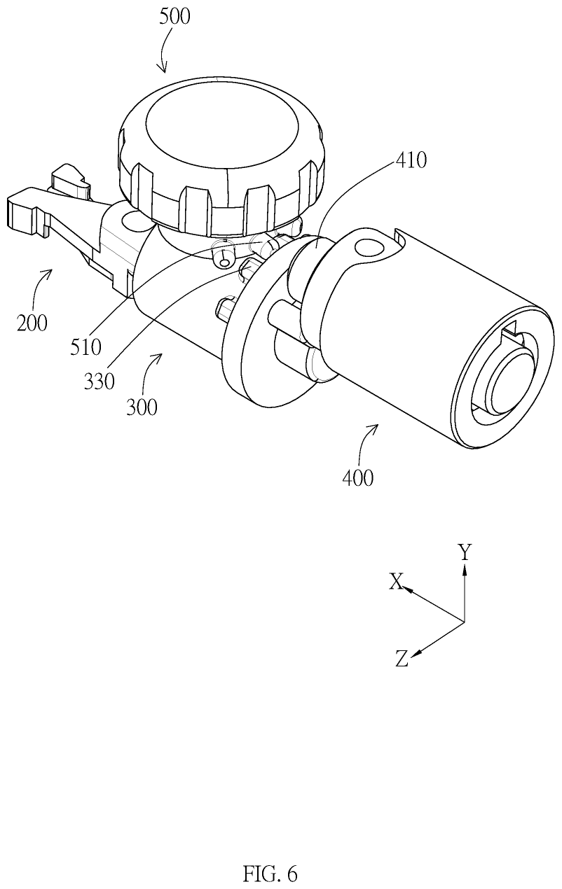

Specifically, as shown in the embodiment in FIG. 6, the lock body includes a movement restricting piece 410. The movement restricting piece 410 is capable of moving along the direction parallel to the X-axis to prop against the driving device 300 when the driving device 300 rotates to the first pre-determined position. A driving device restricting piece 320 is disposed on one side of the driving device 300 with respect to the lock body 400. The movement restricting piece 410 has a restricting hole 411. When the movement restricting piece 410 props against the driving device 300, the driving device restricting piece 320 inserts into the restricting hole 411 to restrict the driving device 300 from rotating. In different embodiments, however, the lock body 400 is capable of restricting the driving device 300 from rotating by other means such as a pin. On the other hand, the lock body 400 could be a key lock, a combination lock, etc.

As shown in the embodiments in FIGS. 2A and 2B, the clamping device 900 further includes a force applying device 500 disposed on a different side of the driving device 300 with respect to the lock body 400. The force applying device 500 is capable of rotating to make the driving device 300 rotate. Moreover, the force applying device 500 is capable of rotating along a plane parallel to the X-Z plane to make the driving device 300 rotate along a plane parallel to the Y-Z plane.

More particularly, as shown in the embodiment in FIG. 6, a plurality of driving bumps 330 are disposed on the circumference of the driving device 300. A plurality of force applying bumps 510 are disposed on the circumference of the force applying device 500, wherein the force applying bumps 510 are capable of engaging with the driving bumps 330. When the force applying device 500 rotates along a plane parallel to the X-Z plane, the force applying bumps 510 rotate together to push the driving bumps 330 and hence make the driving device 300 rotate along a plane parallel to the Y-Z plane. In different embodiments, however, the force applying device 500 is capable of making the driving device 300 rotate by other means such as a gear.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A clamping device for engaging with a lock hole of an electronic device, comprising:
a body:
at least a hook supported by the body, wherein the hook is capable of moving selectively to a first locked position and an unlocked position;
a driving device, wherein a portion of the hook is disposed in the driving device, wherein the hook moves to the first locked position and is capable of engaging with the lock hole when the driving device rotates to a first pre-determined position.

2. The clamping device according to claim 1, wherein the hook is capable of further moving to a second locked position when the driving device rotates to a second pre-determined position.

3. The clamping device according to claim 1, wherein a portion of the hook inside the driving device is propped against the inner wall of the driving device.

4. The clamping device according to claim 3, wherein the distance between the inner wall of the driving device and the rotation axis of the driving device changes along the circumferential direction.

5. The clamping device according to claim 1, wherein the driving device is capable of rotating along a plane parallel to a Y-Z plane, wherein the hook is capable of rotating along a plane parallel to an X-Z plane, wherein an X-axis, a Y-axis, and a Z-axis are orthogonal.

6. The clamping device according to claim 3, further comprising a lock body disposed on a side of the driving device, wherein the lock body is capable of locking to restrict the hook from moving when the driving device rotates to the first pre-determined position.

7. The clamping device according to claim 6, wherein when the driving device rotates to the first pre-determined position, the lock body is capable of locking to restrict the driving device from rotating and hence restrict the hook from moving.

8. The clamping device according to claim 7, wherein the lock body includes a movement restricting piece, wherein the movement restricting piece is capable of moving along the direction parallel to an X-axis to be propped against the driving device when the driving device rotates to the first pre-determined position.

9. The clamping device according to claim 5, further comprising a force applying device disposed on a different side of the driving device with respect to the lock body, wherein the force applying device is capable of rotating to make the driving device rotate.

10. The clamping device according to claim 9, wherein the force applying device is capable of rotating along a plane parallel to the X-Z plane.
